(19) United States
(12) Patent Application Publication
(10) Pub. No.: US 2022/0220027 A1
(43) Pub. Date: Jul. 14, 2022

(54) METHOD FOR DEPOSITING METAL NANOPARTICLES ON A TEXTILE WEB BY PHOTOCATALYSIS, AND CORRESPONDING TEXTILE WEB

(71) Applicants: Brochier Technologies, Villeurbanne (FR); Centre National de la Recherche Scientifique, Paris (FR); Universite Claude Bernard Lyon 1, Villeurbanne (FR)

(72) Inventors: Eric PUZENAT, Lyon (FR); Cédric BROCHIER, Lyon (FR); Davide LORITO, Villeurbanne (FR); Lina LAMAA, Vaulx en Velin (FR); Laure PERUCHON, Villeurbanne (FR)

(73) Assignees: Brochier Technologies, Villeurbanne (FR); Centre National de la Recherche Scientifique, Paris (FR); Universite Claude Bernard Lyon 1, Villeurbanne (FR)

(21) Appl. No.: 17/613,110

(22) PCT Filed: May 5, 2020
(86) PCT No.: PCT/FR2020/050750

§ 371 Date: Nov. 22, 2021

(30) Foreign Application Priority Data
May 23, 2019 (FR) FR1905457

(51) Int. Cl. C03C 25/1065; F21V 8/00; C03C 25/16; C03C 25/1095; D06M 10/06; D06M 11/46; D06M 11/83; D06M 11/79; D06M 23/08; B01J 35/06; B01J 35/00; B01J 21/06; B01J 21/08; B01J 23/42; B01J 23/755; B01J 23/50; B01J 23/52; B01J 23/72; B01J 37/02; B01J 37/34

(52) U.S. Cl. CPC C03C 25/1068; C03C 2218/111; C03C 25/16; C03C 25/1095; D06M 10/06; D06M 11/46; D06M 11/83; D06M 11/79; D06M 23/08; B01J 35/06; B01J 35/004; B01J 21/063; B01J 21/08; B01J 23/42; B01J 23/755; B01J 23/50; B01J 23/52; B01J 23/72; B01J 37/0228; B01J 37/0244; B01J 37/344; C03C 2217/212; C03C 2217/255; C03C 2217/256; C03C 2217/253; G02B 6/001

(57) ABSTRACT

The invention relates to a method for depositing metal particles on a textile support, which comprises:
placing at least one textile sheet (1) made of side-emitting optical fibers (2) in contact with a solution containing at least one ionic precursor of a metal to be deposited, the textile sheet (1) being formed from optical fibers (2) woven in warp and/or weft with binding threads in warp and/or weft, each of the optical fibers (2) having invasive alterations (5) along the fiber and allowing the emission of light propagating in the fiber at these alterations (5), the textile sheet (1) being coated on all or part of the surfaces thereof with a layer of semiconductor particles (4) having photocatalytic properties, the textile sheet (1) and the solution being contained in a space of a reactor (9), the space being free of oxygen;
illuminating the textile sheet (1) by at least one light source (7) connected to all or part of the free ends (6) of the optical fibers (2), the light source generating light radiation suitable for activating the photocatalysis of the semiconductor inducing the deposition of metal particles on the photocatalytic layer (4).

### TECHNICAL FIELD

The invention relates to the field of depositing metal particles on a substrate by photocatalysis. More precisely, the invention relates to a method for depositing metallic particles on a textile support by photocatalysis, as well as the textile support thus coated.

### PRIOR ART

Photo-deposition of metal particles, such as silver, gold, nickel or platinum particles, on a titanium dioxide (TiO₂) based substrate consists of immersing the substrate in an aqueous or alcoholic solution containing an ionic precursor of the metal to be deposited, then irradiating the assembly with a light source for a predefined time. The light source is usually placed at a distance from the substrate so as to ensure illumination of the area to be coated. However, when the surface of the area to be coated is very large, it is necessary to move the source away from the substrate and to adjust the intensity of the radiation in order to ensure uniform illumination of the different portions of the surface to be coated with metal particles. The resulting system is relatively cumbersome. Multiplication of light sources would make it possible to reduce the distances but would also require a complex adjustment of the position of these light sources to ensure a homogeneous illumination of the whole surface to be covered.

### SPECIFICATION

This invention therefore offers an alternative solution for photo-deposition of metal particles that is easier to implement, that saves space, and does not require complex setup steps.

In particular, the solution of this invention not only enables a complete or localized deposition of metallic particles on the surface of a support, regardless of the size of the support, but also the deposition of different types of metallic particles on the same support.

The invention thus provides a method for depositing metal particles on a textile substrate, comprising:
bringing at least one side-emitting fiber optic-based textile sheet into contact with a solution containing at least one ionic precursor of a metal to be deposited, the textile sheet being formed by warp and/or weft optical fibers woven with warp and/or weft binding threads, each of the optical fibers presents invasive alterations along the fiber and that allow light propagation within the fiber to be emitted at these alterations, textile sheet being coated on all or part of its surfaces with a layer of semiconducting particles with photocatalytic properties, the textile sheet and the solution contained in a reactor chamber, the chamber being devoid/free of oxygen;
illuminating the textile sheet using at least one light source connected to all or part of the free ends of the optical fibers, said light source generating light radiation adapted to activate photocatalysis of the semiconductor inducing the deposition of metal particles on the coating layer.

Thus, unlike the solutions of the prior art in which the light radiation is directed towards the substrate to be coated, in this invention the light radiation is emitted by the substrate itself. The textile sheet constitutes both the support to be covered with metal particles and a light guide bringing the light radiation as close as possible to the areas to be covered with metal particles. Irradiation of the semi-conductive particles is therefore optimal.

In practice, the textile sheet may be in fabric, knitted fabric or braided fabric form. The textile sheet is preferably in the form of a fabric composed of warp and weft threads arranged in predetermined patterns according to its application.

Advantageously, the method may include:
immersion of the textile sheet, previously connected or not to the said light source, in a solvent selected from water and/or an alcohol, placed in the chamber of the reactor;
removal of oxygen present in the chamber of the reactor;
said step of bringing the textile sheet into contact with precursor, by injecting the precursor of the metal to be deposited into the solvent;
homogenization of the precursor particles in the solvent; and
said illumination of the textile sheet.

According to one variant, the free ends of all the optical fibers of the textile sheet simultaneously receive said light radiation inducing deposition of metallic particles on all the surfaces of the textile sheet in contact with the solution. In other words, the photocatalytic layer covers the entire textile sheet and the metal particles are evenly distributed over this layer.

According to another variant, the light radiation may be injected simultaneously at the ends of a group of optical fibers of the textile sheet, inducing the localized deposition of metal particles on the textile sheet. In other words, the metal particles are deposited only on the areas of the photocatalytic layer that are illuminated by the optical fibers. The result is a textile sheet with areas covered with metal particles and areas that are not covered.

It is thus understood that by making the choice to illuminate certain optical fibers or not, it is possible to carry out successive deposits of metallic particles of different types on separate zones of the textile sheet. For example, the textile sheet may have a first area covered with metallic particles of a first type, and a second area covered with metallic particles of a second type.

Thus, according to another variant, the method may comprise a first localized deposition of a first type of metallic particles, this first deposition consisting of carrying out the steps of the method described above by illuminating a first group of optical fibers, followed by a second localized deposition of a second type of metallic particles. This second deposit includes, in particular, after the deposit of the first type of metal particles:
injecting a second type of metal to be deposited into the precursor solvent; and
injecting light radiation at the free ends of a second group of optical fibers separate from said first group, inducing localized deposition of the second type of metallic particles on the textile sheet.

In other words, the second localized deposit does not require a complete cleaning of the reactor chamber. In particular, it is sufficient to stop the illumination of the first group of optical fibers, to inject the precursor of the second type of metal into the solvent, to carry out the homogenization of the solution, and then to inject light radiation, also adapted to activate the photocatalysis of the semiconductor, into a second group of optical fibers separate from the first group in order to induce the deposition of the second type of metal particles on the irradiated areas of the textile sheet.

Furthermore, depending on the weaving technique used to weave the optical fibers with the binding threads, it is possible to make the optical fibers visible on only one side or on both sides of the textile sheet and thus obtain a complete or partial deposition of metallic particles on both sides of the sheet or on only one side of the textile sheet.

In practice, the photocatalytic layer is made of a material selected from the group comprising titanium dioxide, zinc oxide, zirconium dioxide, and cadmium sulfide. Preferably, the photocatalytic layer is titanium dioxide (TiO₂) based.

In addition, when the textile sheet coated with metal particles is to be used in an oxygenated, humid or gaseous environment, it is preferable to place a silica-based protective layer under the photocatalytic coating layer, so as to limit the aging of the optical fibers. Thus, the textile sheet may further comprise a silica-based protective layer under the photocatalytic layer.

Furthermore, depending on the intended application of the textile sheet, the metal particles to be deposited may be selected from the group comprising platinum (Pt), nickel (Ni), silver (Ag), gold (Au), copper (Cu), ruthenium (Ru), rhodium (Rh), palladium (Pd), osmium (Os), or even iridium (Ir).

The method of the invention thus offers a multitude of possibilities for the creation of metallized textile sheets. The subject-matter of this invention is a textile sheet coated with metallic particles which may be obtained by the above method.

In particular, the textile sheet shown above comprises metal particles, uniformly distributed on the surface of the photo catalytic layer. For example, the distribution of metal particles on the surface of the photocatalytic layer is selectively made on the actually illuminated photocatalyst grains. The deposited metal particles are advantageously of nanometric size, for example between 1-3 nm or 5-50 nm.

The metallized textile sheet is suitable for a wide range of applications, such as disinfection of a humid or gaseous environment, but also for the production of hydrogen.

### BRIEF DESCRIPTION OF THE FIGURES

Further characteristics and advantages of the invention will become clear from the following description, which is indicative and not limiting, with reference to the attached drawings, in which:

FIG. 1 is a view in perspective of a textile sheet in accordance with an embodiment of the invention;

FIG. 2 is a cross-sectional view of the textile sheet according to an embodiment of the invention in which the photocatalytic layer is deposited on the binding threads before weaving;

FIG. 3 is a cross-sectional view of the textile sheet according to another embodiment of the invention in which the photocatalytic layer is deposited on the optical fibers before weaving;

FIG. 4 is a cross-sectional view of the textile sheet according to another embodiment of the invention in which the photocatalytic layer is deposited on the fabric after weaving;

FIG. 5 is a schematic cross-sectional view of the textile sheet with the optical fibers grouped in bundles and connected to light sources according to a variant of the invention;

FIG. 6 is a schematic cross-sectional view of the textile sheet with the optical fibers grouped in bundles and connected to light sources according to another variant of the invention;

FIG. 7 is a schematic representation of the different stages of the metallization method according to a first embodiment of the invention;

FIG. 8 is a schematic representation of an installation to implement the method of the invention according to one embodiment;

FIG. 9 is a schematic representation of the textile sheet according to one variant in which the metal particles are deposited on the entire surface of one side of the textile sheet;

FIG. 10 is a schematic representation of the textile sheet according to one variant in which the metal particles are deposited on the entire surface of one side of the textile sheet;

FIG. 11A is a schematic representation of the textile sheet according to another variant implementing two successive deposits of metallic particles, FIG. 11A illustrating the first deposit by photocatalysis;

FIG. 11B is a schematic representation of the textile sheet according to another variant implementing two successive deposits of metallic particles, FIG. 11B illustrating the first deposit by photocatalysis;

FIG. 12 is a schematic representation of the textile sheet implemented for hydrogen production.

In these figures, the same references designate identical or similar elements and the different structures are not to scale. Furthermore, only those elements that are essential for understanding the invention are shown in these Figures for the sake of clarity.

### DETAILED DESCRIPTION OF THE INVENTION

The method of the invention for depositing metal particles consists of depositing by photocatalysis metal particles on a woven fiber optic-based textile sheet covered with a semiconducting layer having photocatalytic properties, such as TiO₂. In particular, under ultraviolet (UV) radiation, a reduction reaction of the metal ions on the photocatalyst occurs, metal particles are formed, and these metal particles attach to the TiO₂ layer.

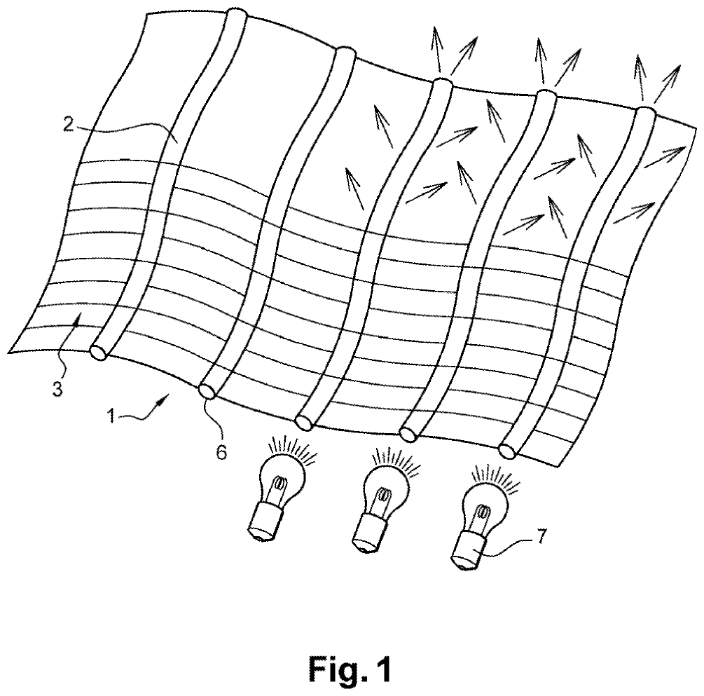

Such a textile sheet according to one embodiment is illustrated in FIG. 1. This textile sheet 1 integrates optical fibers 2 with lateral emission arranged in warp and/or weft and woven with binding threads 3 arranged in warp and/or weft. The free ends 6 of the optical fibers are intended to be connected to a light source 7.

The optical fibers may be based on a polymer and the binding threads may be made of polyester. The optical fibers are uniformly distributed in one plane, parallel to each other. These optical fibers also have invasive alterations on their outer surface, so that light that propagates in the fiber may escape from the fiber through these alterations. These alterations may be created in several ways, including, for example, surface treatments adapted to produce surface modifications of the optical fibers, namely modifications of the geometry and/or physico-chemical properties of the optical fiber surface. These alterations, which allow the light propagating in the fiber to leave the fiber at the level of these alterations, may for example be obtained by sandblasting, chemical etching, or laser treatment methods. In addition, these alterations may be distributed progressively over the surface of the optical fibers in order to ensure homogeneous illumination. The surface density or the size of the alterations may thus vary from one zone to another of the water table. For example, in the vicinity of the light source, the surface density of the alterations may be low, while further away from the source, they become larger. In practice, the distribution of the alterations along the optical fibers is adapted to ensure a homogeneous lateral emission along the entire length of the optical fibers.

In addition, different weaving techniques may be used. For example, it is possible to weave the optical fibers on only one side of the textile sheet, i.e., the textile sheet has only one illuminated side. It is also possible to weave the optical fibers on both sides of the textile sheet, i.e., the textile sheet has two illuminated sides.

The textile sheet is further coated with a semi-conductive particle-based layer with photocatalytic properties, such as for example, titanium dioxide (TiO₂) particles. The photocatalytic particles may be applied to the textile sheet in different ways and may form a layer covering the entire textile sheet or only specific areas, for example, on only one side of the textile sheet. The photocatalytic coating layer may be applied, before weaving, to one or more components of the textile sheet, such as to the binding threads and/or the optical fibers. The photocatalytic layer may also be deposited after weaving on both components of the fabric, and in particular either on the entire fabric formed by the optical fibers associated with the binding threads, or on specific areas of the fabric. In addition, the photocatalytic layer may be deposited in different ways, e.g., by bathing, smearing, emulsion, spraying, printing, encapsulation, electroplating, etc.

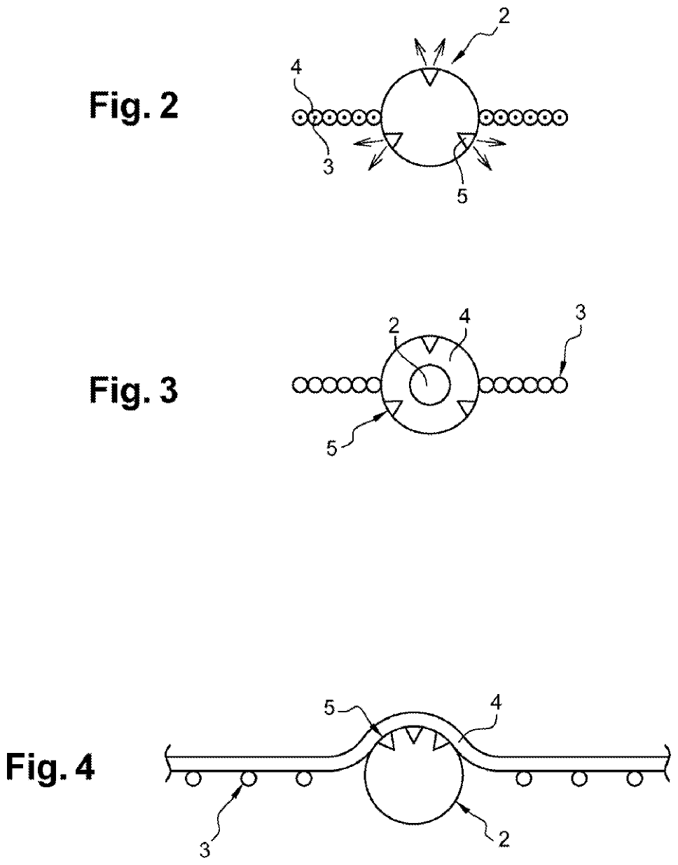

As shown in FIG. 2, the coating layer 4 containing the photocatalytic particles is applied to the binding threads 3 prior to weaving with the optical fibers 2 containing alterations 5. As shown in FIG. 3, the coating layer 4 containing the photocatalytic particles is applied to the optical fibers 2 before weaving with the binding threads 3. As shown in FIG. 4, the coating layer 4 containing the photocatalytic particles is applied, after weaving, to the fabric formed by the optical fibers 2 woven with the binding threads 3.

In addition, to avoid premature aging of the optical fibers caused by titanium dioxide, it is possible to provide for the deposition of a silica-based protective layer prior to the deposition of the photocatalytic layer. Such a protective layer is advantageous if the textile sheet is to be used in an oxygen-containing environment. However, when the textile sheet is to be integrated in an oxygen-free environment, it is preferable to omit such a protective layer. Indeed, the absence of the silica layer (SiO₂) allows deposition of metallic particles of a smaller nanometric size.

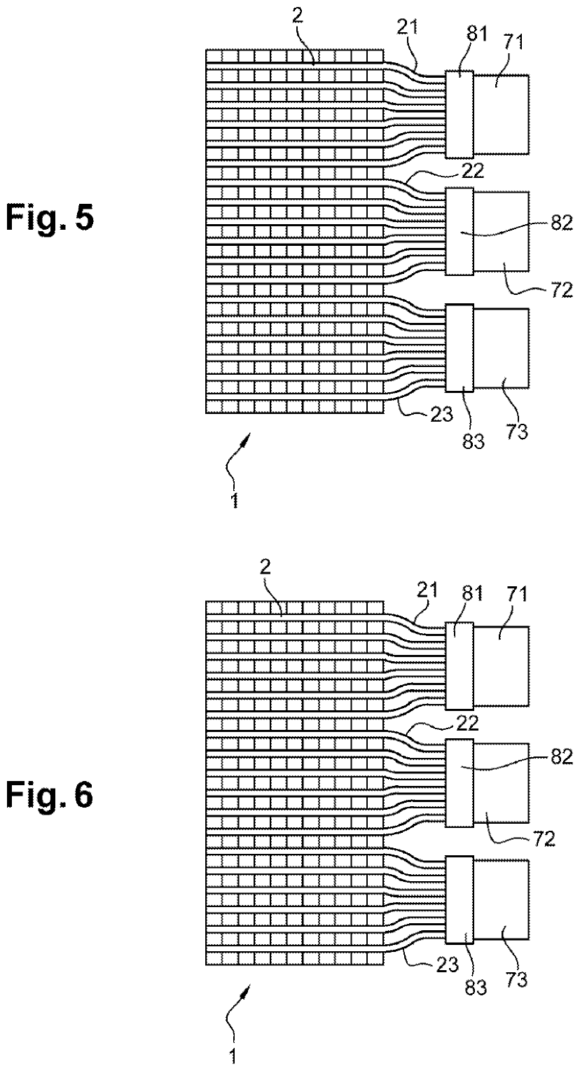

The free ends 6 of the optical fibers 2 are connected to one or more light sources 7 each configured to generate light radiation suitable for causing photocatalysis of the TiO₂ layer. These free ends 6 may or may not be bundled together via ferrules. For example, as shown in FIGS. 5 and 6, the optical fibers 2 are grouped into separate bundles 21, 22, 23 via ferrules 81, 82, 83, and are connected to separate light sources 71, 72, 73. It is thus possible to select the groups of optical fibers to be illuminated and thus the zones of the textile sheet that will be covered with metallic particles. For example, as shown in FIG. 5, all the bundles 21, 22, 23 may be illuminated simultaneously, and as shown in FIG. 6, it is possible to illuminate only one bundle 2. Of course, the skilled person will be able to consider other configurations. The light sources may be of various kinds, and in particular they may be in the form of light-emitting diodes.

Preferably, the light sources 7 are configured to generate light radiation of a wavelength suitable for photocatalysis of the semiconductor particles. For example, for TiO₂ particles, ultraviolet radiation with a wavelength in the range 300 nm to 400 nm is preferred. Preferably, the applied light intensity is at least 0.1 mW/cm².

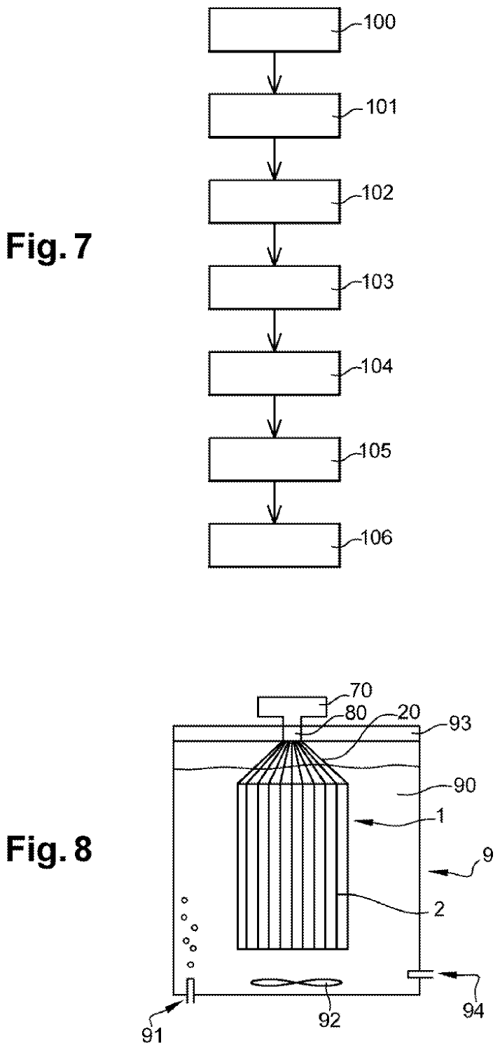

The various steps of the above method for metallizing the textile sheet, according to a particular embodiment, will be detailed below with reference to FIGS. 7 and 8.

Preparation 100 of a solvent 90: first of all, a water and/or alcohol-based solution is prepared to act as a solvent in which the precursor of the metal to be deposited will be injected. In practice, as alcohol has the power to accelerate the photo-deposition reaction, this solution may be for example glycerol, or a hydroalcoholic solution.

Filling 101 of the chamber of the reactor 9: this solution 90 is then placed in the reactor chamber 9, for example a two-phase cylindrical reactor (liquid/gas) integrating a bubbling system 91 of inert gas in vertical direction or a bubbling system via a tube inserted in the reactor. The bubbling system will remove the oxygen (O₂) contained in the volume before the injection of the precursors. Of course, any other volume suitable for the implementation of the method may be used. For example, a single-phase (liquid) reactor may be used. In this case, to eliminate the O₂, a photocatalytic reaction may be carried out to consume the O₂; then the heat may be increased to degas. The reactor 9 may also incorporate a mechanical system, such as a stirrer 92, which will homogenize the precursor injected into the solvent.

Introduction 102 of the textile sheet 1 to be coated with metal particles: the textile sheet 1 coated with a layer of TiO₂ particles is immersed in the water/alcohol solution. In the example shown in FIG. 8, the free ends of the optical fibers 2 of the textile sheet 1 are grouped into a bundle 20, via a ferrule 80 or any other suitable connector. The reactor is then sealed, with the ferrule 80 passing through the reactor lid 93 to allow connection of the bundle to a light source 70, such as an LED, external to the reactor 9 and configured to generate UV radiation. In particular, the use of joints ensures that the chamber of the reactor is sealed.

Deoxygenation 103 of the chamber of the reactor: to eliminate the oxygen (O₂) present in the chamber of the reactor, bubbling of inert gas such as argon or nitrogen is performed, via the bubbling system 91 for example. This step must be performed before the injection of the metal precursor.

Injection 104 of metal precursors: in the absence of light and oxygen, and at room temperature (between 20° C. and 35° C., for example), a predefined volume of a metal precursor solution 94 is injected into the reactor. For example, when platinum is to be deposited on the textile sheet, the precursor solution may be based on chloroplatinic acid (H₂PtCl₆), at the concentration necessary to photo-deposit a determined amount of metal on the titanium dioxide. For example, when silver is to be deposited, the precursor solution may be based on silver nitrate (AgNO₃), and for gold deposition, the precursor solution may be based on chloroauric acid (HAuCl₄). Of course, other precursors may be used. In practice, the amount of precursor is defined as a function of the percentage of metal particles to be deposited on the surface of the substrate.

Homogenization 105 of the precursor in the solvent: after injection, the solution contained in the chamber of the reactor is homogenized. Homogenization may be carried out using the inert gas bubbling system 91. In practice, one waits for at least thirty minutes under inert gas bubbling to ensure that the liquid medium is well mixed, in order to avoid a deposit by conglomerates and on only one part of the textile sheet. Stirring may also be performed using a stirrer 92 to reduce the homogenization time.

Photo-deposition reaction 106: after homogenization, the textile sheet is illuminated by injecting UV radiation into the optical fibers 2 via the light source 70. Metal particles are thus deposited by photo-deposition on the TiO₂ layer illuminated by the optical fibers. Pour le TiO₂, un rayonnement UV de longueur d'onde comprise entre 300 nm et 400 nm peut être approprié.

In practice, a darkening of the surface of the textile sheet is observed due to the presence of the metal. Furthermore, it is observed that all the precursors present in the solution is deposited on the textile sheet in the form of metallic particles. The metal particles deposited on the textile are of nanometric size, generally between 1 nm and 50 nm. The duration of the illumination depends on the type of metal particles to be deposited. Some metals are more easily deposited than others: for example, platinum (Pt) particles are deposited in four (4) hours while nickel (Ni) particles take twelve (12) hours to deposit. On average, the amount of metal particles deposited on the TiO₂ layer relative to the amount of TiO₂ particles present on the textile sheet may advantageously be in the range of 0.1% to 10%.

In conjunction with the photo-deposition, a method may be used to monitor the reaction and verify that all metal particles present in the solution have been deposited on the textile. For example, one might consider monitoring by chemical dosage or by measuring the pH of the solution.

The use of a luminous textile as a support for the photocatalytic semi-conductor optimizes irradiation of the photocatalytic particles. Thus, it has been found that the entirety of the metal precursor present in the solution is deposited as metal particles on the textile sheet. The solution of the invention is therefore a deposition method that does not induce metal particle waste, which therefore does not require effluent reprocessing to recover the metal particles, and which therefore reduces manufacturing costs.

Visualization by microscopy of the textile sheet's state of coloration thus obtained makes it possible to confirm the homogeneous deposit of the metal particles. The textile sheet is generally free of aggregates and the deposited metal particles can therefore all be active.

Thus, on the same principle and using a textile sheet woven according to a weaving technique which makes it possible to make the optical fibers visible on one side or both sides of the textile sheet and by choosing to illuminate certain optical fibers or group of optical fibers or not, it is possible to create textile sheets upon which metallic particles are completely or partially deposited using one or more types of metals. In other words, the use of a luminous textile support based on side-emitting optical fibers makes it possible to create localized photo-deposits as well as successive photo-deposits. Examples of metal deposition configurations are described below.

Photo-deposit on the entire textile sheet: the textile sheet is woven in such a way as to allow the illumination by optical fibers of both sides of the sheet. All optical fibers are connected to a light source and receive UV radiation simultaneously. During photocatalysis, the metal particles are deposited on both surfaces of the sheet.

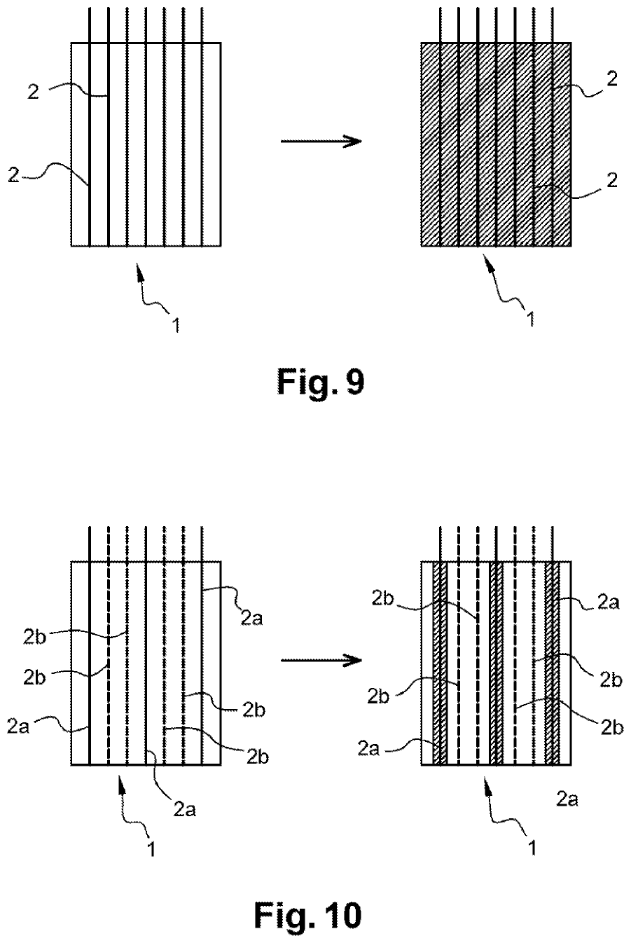

Photo-deposition on one side of the textile sheet: the textile sheet is woven in such a way as to allow the illumination by optical fibers of only one of the two sides of the sheet. All optical fibers are connected to a light source and receive UV radiation simultaneously. During the photocatalysis reaction, the metal particles are only deposited on the surface illuminated by the optical fibers. For example, as shown in FIG. 9, the left figure illustrates the textile sheet before photocatalysis, and the right figure illustrates the textile sheet after photocatalysis. Thus, before photocatalysis, all the optical fibers 2 are connected to the light source, and after photocatalysis, the metal particles are deposited on the entire surface of one side of the textile sheet 1.

Localized/selective photo-deposition on an area of the textile sheet: the textile sheet is woven in such a way as to allow the illumination by optical fibers of one or two sides of the sheet. However, we choose to illuminate only one part of the optical fibers, for example, every other optical fiber or group of optical fibers bundled together. As shown in FIG. 10, the left figure illustrates the textile sheet before photocatalysis, and the right figure illustrates the textile sheet after photocatalysis. Thus, before photocatalysis, the optical fibers 2a (shown as a solid line) are connected to the light source and the optical fibers 2b (shown as a dotted line) are not connected to a light source. After photocatalysis, only the areas around the illuminated optical fibers show a deposit of metal particles.

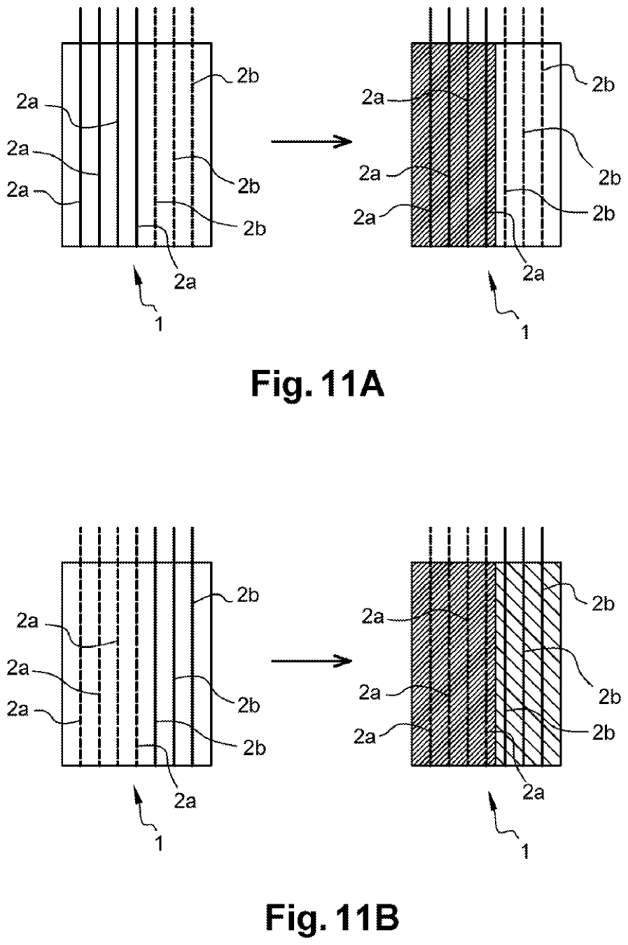

Multi-photo-deposits located on specific areas of the textile sheet: the textile sheet is woven in such a way as to allow the illumination by optical fibers of one or two sides of the sheet. A succession of deposits is carried out by photocatalysis so as to deposit several types of metal particles on separate zones of the textile sheet. As shown in FIG. 11A, the figure on the left illustrates the textile sheet prior to the first photocatalytic deposition, and the right figure shows the textile sheet after the first photocatalytic deposition. Thus, before photocatalysis, the optical fibers 2a, which may be bundled, are connected to the light source and the optical fibers 2b (shown as a dotted line) are not connected to a light source. After photocatalysis, metal particles of a first type are fixed to the areas corresponding to optical fibers 2a. As shown in FIG. 11B, the left figure illustrates the textile sheet before the second photocatalytic deposition, and the right figure illustrates the textile sheet after the second photocatalytic deposition. Thus, before photocatalysis, the optical fibers 2a, which may be bundled, are connected to the light source and the optical fibers 2b (shown as a dotted line) are not connected to a light source. After photocatalysis, metal particles of a second type are fixed to the areas corresponding to optical fibers 2b. We may thus imagine multifunctional textile sheets.

Of course, following the same principle, one may choose to weave the optical fibers so that one group of optical fibers diffuses only on one side of the textile sheet and a second group of optical fibers diffuses only on the opposite side of the textile sheet. In this way, it is possible to deposit a first type of metal particles on one side that may have, for example, antibacterial properties, and to deposit on the other side a second type of metal particles, that may be suitable for the treatment of pollutants.

It is also possible to simultaneously immerse several textile sheets in the solution containing the precursor and to modulate the connection of the optical fibers of each sheet so as to carry out a simultaneous photo-deposition on the sheets in identical or different configurations. This solution is a time-saver.

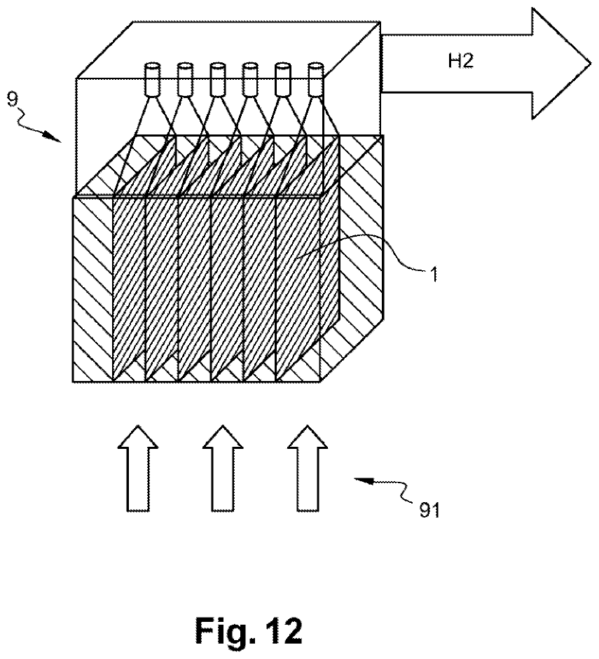

Such metallized textile sheets may be used in various applications, such as in hydrogen (H₂) production. In particular, the textile sheets may be placed in a reactor chamber under pressure. As schematically illustrated in FIG. 12, one or more textile sheets 1 upon which platinum particles, for example, are deposited are placed in a reactor 9. The optical fibers are connected to light sources, and the textile sheets are immersed in an alcoholic solution contained in the chamber of the reactor. The alcoholic solution may be glycerol (synthetic or natural). The chamber of the reactor is also kept at a certain temperature, for example, 40° C. An inert gas such as argon or nitrogen is fed into the volume, for example by a bubbling system 91, which also allows the hydrogen bubbles formed on the surfaces of the textile sheets to be dislodged. Such an installation is space-saving and the hydrogen produced may be stored for later use, for example as a fuel.

According to one embodiment, the hydrogen production process may be carried out in the same reactor, just after the photo-deposition of the metal particles. It is then sufficient to adapt the environment of the reactor chamber for the production of hydrogen.

The textile sheets may also be used for the disinfection of an oxygenated environment, for example, the inactivation of bacteria, viruses, molds, or other organic molecules present in the air and in the water. For example, the textile sheet makes it possible to prevent the formation of biofilms and may also be used for the treatment of aqueous or gaseous effluents.

1. Method for depositing metal particles on a textile support, characterized in that it comprises:
bringing at least one side-emitting fiber optic-based (2) textile sheet (1) into contact with a solution containing at least one ionic precursor of a metal to be deposited;
the textile sheet (1) being formed of warp and/or weft optical fibers (2) woven with warp and/or weft binding threads, each of the optical fibers (2) having invasive alterations (5) along the fiber and that allow light propagation within the fiber to be emitted at these alterations (5),
the textile sheet (1) being coated on all or part of its surfaces with a layer of semiconducting particles (4) having photocatalytic properties, the textile sheet (1) and the solution being contained in a reactor chamber (9),
the chamber being free of oxygen;
illumination of the textile sheet (1) by at least one light source (7) connected to all or part of the free ends (6) of the optical fibers (2), said light source generating a light radiation adapted to activate the photocatalysis of the semi-conductor inducing the deposition of metallic particles on the photocatalytic layer (4).

2. Method according to claim 1, further comprising:
immersion of the textile sheet (1) in a solvent selected from water and/or an alcohol, placed in the reactor chamber (9);
removal of oxygen present in the chamber of the reactor (9);
said contact made by injecting the ionic precursor of the metal to be deposited into the solvent;
homogenization of the precursor particles in the solvent; and
said illumination of the textile sheet (1).

3. Method according to claim 1, wherein the free ends (6) of all the optical fibers (2) of the textile sheet (1) simultaneously receive said light radiation inducing deposition of metallic particles on all the surfaces of the textile sheet (1) in contact with the solution.

4. Method according to claim 1, wherein the light radiation is injected simultaneously at the ends of a group of optical fibers (2) of the textile sheet (1), inducing the localized deposition of metal particles on the textile sheet (1).

5. Method according to claim 4, further comprising, after said localized deposition:
injecting another type of metal to be deposited into the precursor solvent; and
injecting light radiation at the free ends of another group of optical fibers, the light radiation being adapted to activate the photocatalysis of the semiconductor, inducing the localized deposition of the metal particles of said other metal on the textile sheet.

6. Method according to claim 1, wherein the layer of semi-conductive particles (4) comprises titanium dioxide particles.

7. Method according to claim 1, wherein the textile sheet further comprises a silica-based protective layer under the layer of semi-conductive particles (4).

8. Method according to claim 1, wherein the metal particles to be deposited are selected from the group comprising platinum (Pt), nickel (Ni), silver (Ag), gold (Au), copper (Cu), ruthenium (Ru), rhodium (Rh), palladium (Pd), osmium (Os), iridium (Jr).

9. Method according to claim 1, wherein the metal particles to be deposited are platinum (Pt) or nickel (Ni) particles.

10. Method according to claim 1, wherein the metal particles to be deposited are selected from the group comprising silver (Ag), gold (Au) and copper (Cu).

11. Textile sheet coated with metallic particles obtained by the method according to claim 1.

12. Application of the textile sheet according to claim 11, for the production of hydrogen or for the treatment of organic molecules present in a liquid or gaseous medium.
